(19) United States
(12) Patent Application Publication
(10) Pub. No.: US 2008/0034167 A1
(43) Pub. Date: Feb. 7, 2008

(54) Processing a SCSI reserve in a network implementing network-based virtualization

(75) Inventors: Samar Sharma, San Jose, CA (US); Dinesh G. Dutt, Sunnyvale, CA (US); Fabio R. Maino, Palo Alto, CA (US); Sanjaya Kumar, Fremont, CA (US)

Correspondence Address: BEYER WEAVER LLP, P.O. BOX 70250, OAKLAND, CA, 94612-0250, US

(73) Assignee: Cisco Technology, Inc.

(21) Appl. No.: 11/499,372

(22) Filed: Aug. 3, 2006

(51) Int. Cl. G06F 12/14

(52) U.S. Cl. 711/152

(57) ABSTRACT

Methods and apparatus for processing a reserve request requesting a reservation of at least a portion of a volume in a system implementing network-based virtualization of storage are disclosed. More particularly, multiple ports and/or network devices together implement the virtualization of storage. When a network device or port receives a reserve request from a host requesting that at least a portion of a volume be reserved, a notification is sent indicating the at least a portion of the volume being reserved. The notification may be sent to one or more network devices or ports. A lock corresponding to the reserve request may then be obtained such that a lock of the at least a portion of the volume is acquired. When another network device or port receives a reserve intention notification, the network device or port stores information indicating that a lock of the at least a portion of the volume has been obtained. Using this information, network devices and/or ports may appropriately handle subsequent reserve requests.

### BACKGROUND OF THE INVENTION

1. Field of the Invention

The present invention relates to network technology. More particularly, the present invention relates to methods and apparatus for processing a SCSI reserve in a system implementing virtualization of storage within a storage area network.

2. Description of the Related Art

In recent years, the capacity of storage devices has not increased as fast as the demand for storage. Therefore a given server or other host must access multiple, physically distinct storage nodes (typically disks). In order to solve these storage limitations, the storage area network (SAN) was developed. Generally, a storage area network is a high-speed special-purpose network that interconnects different data storage devices and associated data hosts on behalf of a larger network of users. However, although a SAN enables a storage device to be configured for use by various network devices and/or entities within a network, data storage needs are often dynamic rather than static.

The concept of virtual memory has traditionally been used to enable physical memory to be virtualized through the translation between physical addresses in physical memory and virtual addresses in virtual memory. Recently, the concept of “virtualization” has been implemented in storage area networks through various mechanisms. Virtualization interconverts physical storage and virtual storage on a storage network. The hosts (initiators) see virtual disks as targets. The virtual disks represent available physical storage in a defined but somewhat flexible manner. Virtualization provides hosts with a representation of available physical storage that is not constrained by certain physical arrangements/allocation of the storage.

Virtualization in the storage array is one of the most common storage virtualization solutions in use today. Through this approach, virtual volumes are created over the storage space of a specific storage subsystem (e.g., disk array). Creating virtual volumes at the storage subsystem level provides host independence, since virtualization of the storage pool is invisible to the hosts. In addition, virtualization at the storage system level enables optimization of memory access and therefore high performance. However, such a virtualization scheme typically will allow a uniform management structure only for a homogenous storage environment and even then only with limited flexibility. Further, since virtualization is performed at the storage subsystem level, the physical-virtual limitations set at the storage subsystem level are imposed on all hosts in the storage area network. Moreover, each storage subsystem (or disk array) is managed independently. Virtualization at the storage level therefore rarely allows a virtual volume to span over multiple storage subsystems (e.g., disk arrays), thus limiting the scalability of the storage-based approach.

When virtualization is implemented on each host, it is possible to span multiple storage subsystems (e.g., disk arrays). A host-based approach has an additional advantage, in that a limitation on one host does not impact the operation of other hosts in a storage area network. However, virtualization at the host-level requires the existence of a software layer running on each host (e.g., server) that implements the virtualization function. Running this software therefore impacts the performance of the hosts running this software. Another key difficulty with this method is that it assumes a prior partitioning of the available storage to the various hosts. Since such partitioning is supported at the host-level and the virtualization function of each host is performed independently of the other hosts in the storage area network, it is difficult to coordinate storage access across the hosts. The host-based approach therefore fails to provide an adequate level of security. Due to this security limitation, it is difficult to implement a variety of redundancy schemes such as RAID which require the “locking” of memory during read and write operations. In addition, when mirroring is performed, the host must replicate the data multiple times, increasing its input-output and CPU load, and increasing the traffic over the SAN.

Virtualization in a storage area network appliance placed between the hosts and the storage solves some of the difficulties of the host-based and storage-based approaches. The storage appliance globally manages the mapping and allocation of physical storage to virtual volumes. Typically, the storage appliance manages a central table that provides the current mapping of physical to virtual. Thus, the storage appliance-based approach enables the virtual volumes to be implemented independently from both the hosts and the storage subsystems on the storage area network, thereby providing a higher level of security. Moreover, this approach supports virtualization across multiple storage subsystems. The key drawback of many implementations of this architecture is that every input/output (I/O) of every host must be sent through the storage area network appliance, causing significant performance degradation and a storage area network bottleneck. This is particularly disadvantageous in systems supporting a redundancy scheme such as RAID, since data must be mirrored across multiple disks. In another storage appliance-based approach, the appliance makes sure that all hosts receive the current version of the table. Thus, in order to enable the hosts to receive the table from the appliance, a software shim from the appliance to the hosts is required, adding to the complexity of the system. Moreover, since the software layer is implemented on the host, many of the disadvantages of the host-based approach are also present.

Patent application Ser. No. 10/056,238, Attorney Docket No. ANDIP003, entitled “Methods and Apparatus for Implementing Virtualization of Storage in a Storage Area Network,” by Edsall et al, filed on Jan. 23, 2002, which is incorporated herein by reference for all purposes, discloses a system in which network-based virtualization is supported. In other words, virtualization is supported in the network, rather than at the hosts or storage devices. In this system, virtualization is supported by one or more network devices placed in a data path between the hosts and the storage devices. More particularly, virtualization may be implemented on a per-port basis via “intelligent ports.” Often, when a host performs a read or write operation, the corresponding storage locations are “locked” to prevent other network devices from modifying the data that is being accessed or modified. This is typically implemented by acquiring a lock prior to a read or write operation, and releasing the lock after the read or write operation is completed. In a system implementing network-based virtualization, locking of storage locations becomes more complex. For instance, one host might lock a particular segment of memory via one network device or port, while another host might attempt to access that same segment of memory via another network device or port. Unfortunately, neither host will be aware of the conflicting locking problem and data corruption may occur.

In view of the above, it would be desirable if the locking problem occurring in a system implementing network-based virtualization could be eliminated.

### SUMMARY OF THE INVENTION

The disclosed embodiments enable the locking of a volume or portion thereof in a system implementing network-based virtualization of storage to be managed. This is accomplished, in part, through supporting communication among multiple network devices and/or ports that are capable of accessing, modifying and/or reserving the volume. Such communication may be implemented to obtain a lock of at least a portion of a volume or, alternatively, to release such a lock.

In accordance with one embodiment, there are four types of reservations that may be performed to reserve a volume or portion thereof. The four types of reservations include: read exclusive, write exclusive, exclusive access, and read shared.

In accordance with one aspect of the invention, when a network device wishes to reserve a volume or portion thereof, it sends a reserve request. The reserve request may indicate a particular type of reservation. Thus, in accordance with one embodiment, the reserve request may be a read exclusive request, a write exclusive request, an exclusive access request, or a read shared request.

In accordance with another aspect of the invention, when a reserve request is received from a host, a reserve intention notification indicating at least a portion of a volume being reserved is sent. A lock corresponding to the reserve request may then be obtained such that a lock of the portion of the volume is acquired. The lock may be obtained, for example, after the reserve intention notification has been sent or after an acknowledgement message has been received from the receiver of the reserve intention notification. Such an acknowledgement message may indicate that the notification has been received or may further indicate that the party sending the acknowledgement is unaware of a reservation conflict.

In accordance with one embodiment, a reserve intention notification is sent only after checking if a reservation conflict exists. If a reservation conflict exists, it is unnecessary to send a reserve intention notification. If there is no reservation conflict, a reserve intention notification is sent.

In accordance with another embodiment, the network device (or port) receiving the reserve request from the host sends a reserve intention notification directly to a set of one or more network devices and/or ports that export the volume. In some embodiments, the network device (or port) receiving the reserve request from the host sends a reserve intention notification to an arbitrator, which may be implemented at a separate network device or port of a network device. For instance, a different arbitrator may be associated with each volume or set of volumes. An arbitrator may function to determine whether a reservation conflict exists and/or to notify the network device(s) and/or port(s) that export the volume. In the event that the arbitrator is responsible for notifying the interested parties, the arbitrator may send one or more reserve intention notifications to the network device(s) and/or port(s) that export the volume. However, in the event that the arbitrator is primarily responsible for determining whether a reservation conflict exists, the network device (or port) receiving the reserve request may send a reserve intention notification directly to one or more network devices and/or ports upon receiving an acknowledgement from the arbitrator that indicates that no reservation conflict exists.

In accordance with one embodiment, a lock may be acquired after acknowledgement of the reserve intention notification(s) has been received. Such an acknowledgement may be received directly from the network device(s) or port(s) receiving the reserve intention notification(s) or, alternatively, an acknowledgement may be received from an arbitrator that has notified the appropriate network device(s) or port(s).

In accordance with yet another aspect of the invention, when a network device no longer wishes to reserve a volume or portion thereof, it sends a release request requesting a release of at least a portion of the volume. The release request may indicate a particular type of reservation such as that set forth above. In other words, a release request may correspond to a particular reserve request.

In accordance with another aspect of the invention, when a release request is received from a host, a release notification indicating at least a portion of a volume is no longer reserved is sent. A lock corresponding to the release request may be released such that the lock of the portion of the volume is released.

In accordance with one embodiment, the network device (or port) receiving a release request from the host sends a release notification to a set of ports that export the volume. This may be accomplished by sending a release notification to an arbitrator, which then sends a release notification to a set of ports that export the volume. The arbitrator may then send one or more release notifications to the network device(s) and/or port(s) that export the volume.

In accordance with another embodiment, when a reserve request or reserve notification is received, it is possible to determine whether a reservation conflict exists. This may be accomplished by accessing reserve information for a set of ports that export the volume (or portion thereof) being reserved. The reserve information may be stored locally (e.g., by the network device or port) and/or may be stored on a separate network device (e.g., shared disk). Upon confirmation that no reservation conflict exists, the reserve information may be updated to indicate that the volume or portion thereof is being reserved. The reserve information may indicate the portion(s of the volume being reserved, as well as the entity or port reserving the portion(s) of the volume. Similarly, the reserve information may be updated in response to a release request or release notification.

Various network devices may be configured or adapted for performing the disclosed functionality. These network devices include, but are not limited to, servers (e.g., hosts), routers, and switches. Moreover, the functionality for the disclosed processes may be implemented in software as well as hardware.

Yet another aspect of the invention pertains to computer program products including machine-readable media on which are provided program instructions for implementing the methods and techniques described above, in whole or in part. Any of the methods of this invention may be represented, in whole or in part, as program instructions that can be provided on such machine-readable media. In addition, the invention pertains to various combinations and arrangements of data generated and/or used as described herein.

These and other features of the present invention will be described in more detail below in the detailed description of the invention and in conjunction with the following figures.

### BRIEF DESCRIPTION OF THE DRAWINGS

FIG. 1 is a block diagram illustrating an exemplary system architecture in which various embodiments of the invention may be implemented.

FIG. 2 is a process flow diagram illustrating a method of processing a reserve request via message passing between ports in accordance with a first embodiment of the invention.

FIGS. 3A-3B are exemplary data structures that may be used for storing reserve information for a plurality of ports in accordance with a second embodiment of the invention.

FIG. 4 is a process flow diagram illustrating a method of processing a reserve request using message passing between ports and reserve information that is stored for the ports in accordance with the second embodiment of the invention.

FIG. 5 is a process flow diagram illustrating a method of processing reserve requests via an arbitrator in accordance with a third embodiment of the invention.

FIG. 6 is a process flow diagram illustrating a method of processing reserve requests via an arbitrator implemented at a single port in accordance with a fourth embodiment of the invention.

FIG. 7 is a process flow diagram illustrating a method of processing reserve requests via an arbitrator implemented at a master port for the volume in accordance with a fifth embodiment of the invention.

FIG. 8A is a block diagram illustrating an exemplary virtualization switch in which various embodiments of the present invention may be implemented.

FIG. 8B is a block diagram illustrating an exemplary standard switch in which various embodiments of the present invention may be implemented.

### DETAILED DESCRIPTION OF THE PREFERRED EMBODIMENTS

In the following description, numerous specific details are set forth in order to provide a thorough understanding of the present invention. It will be obvious, however, to one skilled in the art, that the present invention may be practiced without some or all of these specific details. In other instances, well known process steps have not been described in detail in order not to unnecessarily obscure the present invention.

The disclosed embodiments support the management of locks that are requested and acquired in a system implementing virtualization of storage. More particularly, the embodiments described herein may be implemented in a system implementing network-based virtualization. In a system implementing network-based virtualization, virtualization may be implemented across multiple ports and/or network devices such as switches or routers. As a result, commands such as read or write commands addressed to a volume may be intercepted by different network devices (e.g., switches, routers, etc.) and/or ports. The disclosed embodiments alleviate the locking problem that results in such a system.

A reserve request is typically sent by a host to reserve a volume or portion thereof in order to perform a read or write operation. Such a reserve request typically indicates the type of reservation being requested.

In accordance with one embodiment, there are four types of reservations that may be performed in order to reserve an entire volume or portion (e.g., extent) thereof. The four types of reservations include: read exclusive, write exclusive, exclusive access, and read shared. When a read exclusive reservation is obtained, no other initiator is permitted to perform read operations on the indicated extent(s) (or volume). However, a read exclusive reservation does not prevent write operations from being performed by another initiator. Similarly, when a write exclusive reservation is obtained, no other initiator is permitted to perform write operations on the indicated extent(s) (or volume). However, a write exclusive reservation does not prevent read operations from being performed by another initiator. An exclusive access reservation prevents all other initiators from accessing the indicated extent(s) (or volume). All reservation types that overlap these extent(s) conflict with this reservation. A read shared reservation prevents write operations from being performed by any initiator on the indicated extent(s) (or volume). This reservation does not prevent read operations from being performed by any other initiator. Although these types of reservations are supported in a system implementing the SCSI protocol, these examples are merely illustrative, and therefore the disclosed embodiments may be implemented in systems supporting different protocols, as well as different types of reservations.

When a host wishes to access a volume or portion thereof in order to read and/or write to the volume or portion thereof, the host will typically send a reserve request in order to “lock” the corresponding storage locations. In order to obtain a lock of the volume or portion thereof, one or more network devices and/or ports are notified of the lock. These notifications may serve a variety of purposes. For instance, such notifications enable the network devices and/or ports to update their information so as to prevent any subsequent reservation conflicts from occurring. As another example, in the event that the network devices and/or ports receiving a notification are aware of a conflict, they may respond to prevent a new lock from being obtained. Accordingly, through communication between or among the network devices and/or ports, the locking problem and data corruption that can occur in such a system may be eliminated.

In accordance with one embodiment, a volume is exported by one or more ports. The ports that export a particular volume may be implemented in one or more network devices within the network. In accordance with one embodiment, the ports may be intelligent ports (i.e., I-ports) implemented in a manner such as that disclosed in patent application Ser. No. 10/056,238, Attorney Docket No. ANDIP003, entitled “Methods and Apparatus for Implementing Virtualization of Storage in a Storage Area Network,” by Edsall et al, filed on Jan. 23, 2002. An I-port may be implemented as a master port, which may send commands or information to other I-ports. In contrast, an I-port that is not a master port may contact the master port for a variety of purposes, but cannot contact the other I-ports. In a Fibre Channel network, the master I-port for a particular volume may maintain the identity of the other I-ports that also export the volume in the form of a World Wide Name (WWN) and/or Fibre Channel Identifier (FCID). Similarly, the other I-ports that export the volume may maintain the identity of the master I-port in the form of a WWN and/or FCID. In other embodiments, it is contemplated that the system does not include a master I- port, and therefore the I-ports maintain the identity of the other I-ports that export the volume to which they send notifications.

In accordance with some embodiments of the invention, a master port functions as an arbitrator for the purpose of sending notifications to other ports exporting the volume, determining whether a reservation conflict exists based upon local or global reservation information, and/or updating reservation information accordingly. In addition, the master port may also function as a master port for purposes of implementing virtualization functionality. More particularly, a master port may be implemented in a manner such as that disclosed in patent application Ser. No. 10/056,238, Attorney Docket No. ANDIP003, entitled “Methods and Apparatus for Implementing Virtualization of Storage in a Storage Area Network,” by Edsall et al, filed on Jan. 23, 2002.

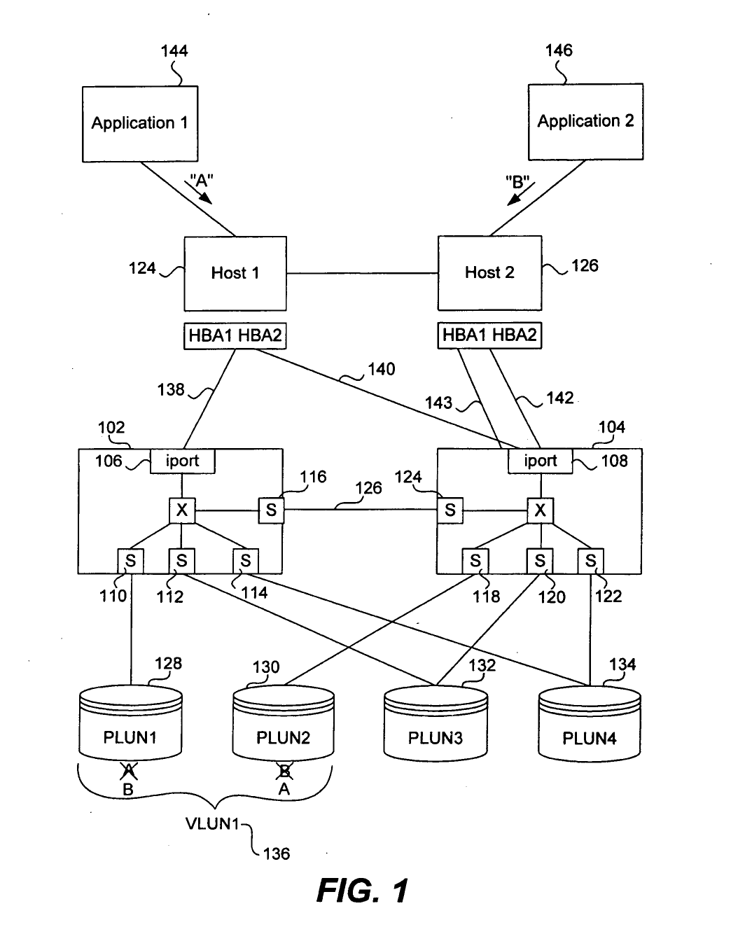

In accordance with one embodiment, a storage area network may be implemented with virtualization switches adapted for implementing virtualization functionality, as well as with standard switches. FIG. 1 is a block diagram illustrating an exemplary system architecture in which various embodiments of the invention may be implemented. In this example, two virtualization switches 102 and 104 are implemented to support transmission of frames within the storage area network. Each virtualization switch may include one or more “intelligent” ports as well as one or more standard ports. More specifically, the virtualization switches 102 and 104 in this example each have an intelligent port 106 and 108, respectively. In addition, each of the virtualization switches 102 and 104 has multiple standard ports 110, 112, 114, 116 and 118, 120, 122, 124, respectively.

In order to support the virtual-physical mapping and accessibility of memory by multiple applications and/or hosts, it is desirable to coordinate memory accesses between the virtualization switches 102 and 104. Communication between the switches 102 and 104 may be accomplished by an inter-switch link 126 between two switches. As shown, the inter-switch link 126 may be between two standard ports. In other words, synchronization of memory accesses by two switches merely requires communication between the switches. This communication may be performed via intelligent virtualization ports, but need not be performed via a virtualization port or between two virtualization ports.

Virtualization of storage is performed for a variety of reasons, such as mirroring. For example, consider four physical Logical Units (LUNs) LUNs, PLUN1 128, PLUN2 130, PLUN3 132, and PLUN4 134. It is often desirable to group two physical LUNs for the purpose of redundancy. Thus, as shown, two physical LUNs, PLUN1 128 and PLUN2 130 are represented by a single virtual LUN, VLUN1 136. When data is mirrored, the data is mirrored (e.g., stored) in multiple physical LUNs to enable the data to be retrieved upon failure of one of the physical LUNs.

Various problems may occur when data is written to or read from one of a set of “mirrors.” For instance, multiple applications running on the same or different hosts, may simultaneously access the same data or memory location (e.g., disk location or disk block), shown as links 138, 140. Similarly, commands such as read or write commands sent from two different hosts, shown at 138, 140 and 142, 143 may be sent in the same time frame. Each host may have corresponding Host Bus Adapters (HBA) as shown. Ideally, the data that is accessed or stored by the applications or hosts should leave the mirrors intact. More particularly, even after a write operation to one of the mirrors, the data stored in all of the mirrors should remain consistent. In other words, the mirrors should continue to serve as redundant physical LUNs for the other mirrors in the event that one of the mirrors should fail.

In conventional systems in which mirroring is enabled, a relatively simultaneous access by two different sources often results in an inherent race condition. For instance, consider the situation when two different clients send a write command to the same virtual LUN. As shown, application 1 144 running on Host 1 124 sends a write command with the data “A,” while application 2 146 running on Host 2 126 sends a write command with the data “B.” If the first application 144 sends data “A” to VLUN1 136 first, the data “A” may be written, for example, to PLUN1 128. However, before it can be mirrored to PLUN2 130, the second application 146 may send data “B.” Data “B” may be written to PLUN2 130 prior to being mirrored to PLUN1 128. Data “A” is then mirrored to PLUN2 130. Similarly, data “B” is mirrored to PLUN1 128. Thus, as shown, the last write operation controls the data to be stored in a particular physical LUN. In this example, upon completion of both mirror operations, PLUN1 128 stores data “B” while PLUN2 130 stores data “A.” Thus, the two physical LUNs no longer mirror one another, resulting in ambiguous data.

In order to solve the inherent race condition present in conventional systems, the virtualization ports communicate with one another, as described above, via an inter-switch link such as 126. In other words, the ports synchronize their access of virtual LUNs with one another. This is accomplished, in one embodiment, through the establishment of a single master virtualization port that is known to the other virtualization ports as the master port. The identity of the master port may be established through a variety of mechanisms. As one example, the master port may send out a multicast message to the other virtualization ports indicating that it is the master virtualization port. As another example, the virtualization ports may be initialized with the identity of the master port. In addition, in the event of failure of the master virtualization port, it may be desirable to enable one of the slave virtualization ports to substitute as a master port.

The master virtualization port may solve the problem caused due to the inherent race condition in a variety of ways. One solution is a lock mechanism. An alternative approach is to redirect the SCSI command to the master virtualization port, which will be in charge of performing the virtual to physical mapping as well as the appropriate interlocking. The slave port may then learn the mapping from the master port as well as handle the data.

Prior to accessing a virtual LUN, a slave virtualization port initiates a conversation with the master virtualization port to request permission to access the virtual LUN. This is accomplished through a locking mechanism that locks access to the virtual LUN until the lock is released. For instance, the slave virtualization port (e.g., port 106) may request the grant of a lock from the master virtualization port (e.g., port 108). The master virtualization port then informs the slave virtualization port when the lock is granted. When the lock is granted, access to the corresponding physical storage locations is “locked” until the lock is released. In other words, the holder of the lock has exclusive read and/or write access to the data stored in those physical locations. In this example, data “A” is then stored in both physical LUN1 128 and physical LUN2 130. When the slave virtualization port 106 receives a STATUS OK message indicating that the write operation to the virtual LUN was successful, the lock may be released. The master virtualization port 108 may then obtain a lock to access of the virtual LUN until data “B” is stored in both mirrors of the VLUN1 136. In this manner, virtualization ports synchronize access to virtual LUNs to ensure integrity of the data stored in the underlying physical storage mediums.

In accordance with one embodiment, slave and master virtualization ports may be configured or adapted for performing SCSI reserve operations such as those described herein. More particularly, select ports may access reserve information indicating the portion(s) of a volume being reserved (and possibly the port requesting the reservation) and/or communicate with one another regarding SCSI reserve processes, as will be described in further detail below.

In accordance with one embodiment, the disclosed methods may be implemented by one or more ports. For instance, each port implementing one or more of the disclosed methods may be an intelligent port such as that disclosed in patent application Ser. No. 10/056,238, Attorney Docket No. ANDIP003, entitled “Methods and Apparatus for Implementing Virtualization of Storage in a Storage Area Network,” by Edsall et al, filed on Jan. 23, 2002, which is incorporated herein by reference for all purposes. Alternatively, the disclosed methods may be implemented by one or more network devices.

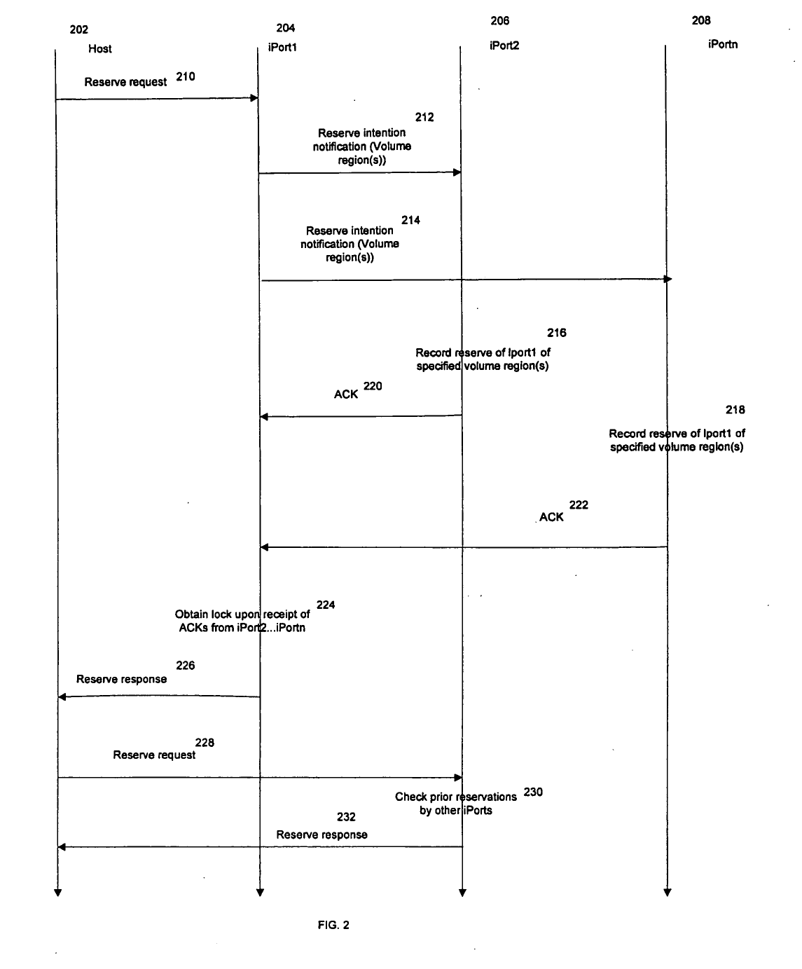

In order to reserve a volume or portion thereof, a host may transmit a reserve request. Similarly, in order to release the reservation of the volume or portion thereof, the host may send a release request. Various methods of processing reserve requests and corresponding release requests will be described in further detail below with reference to FIGS. 2-7.

FIG. 2 is a process flow diagram illustrating a method of processing a reserve request via message passing between ports in accordance with a first embodiment of the invention. Steps performed by a host, a port receiving a reserve request, and other ports exporting a volume are described with respect to corresponding vertical lines 202, 204, and 206-208, respectively. As shown in FIG. 2, when a host sends a reserve request 210 to a port, iPort1, the port sends a reserve intention notification to a set of ports exporting the volume at 212 and 214. Each reserve intention notification may identify the port from which the notification has been sent (i.e., the port that has received the reserve request). As shown, each reserve intention notification indicates the portion(s) of the volume being reserved.

Each port receiving a reserve intention notification may check whether a reservation conflict exists (e.g., by accessing local or global reserve information) and, upon determining that no reservation conflict exists, may store reserve information indicating that a lock of the portion(s) of the volume has been obtained as shown at 216 and 218, as appropriate. This information may also identify the port from which the notification has been sent (i.e., port that has received the reserve request). The ports receiving these notifications may also send an acknowledgement as shown at 220 and 222 to acknowledge the receipt of the notifications and/or indicate that no reservation conflict exists. The port that has received the reserve request may then obtain a lock of the portion of the volume being reserved at 224. More particularly, the port may wait until it receives an acknowledgement from each of the ports to which a reserve intention notification was sent prior to obtaining the lock. The port may then send a reserve response to the host at 226 indicating whether the portion of the volume has been reserved as requested.

When a reserve request is received by one of the ports that exports the volume such as iPort2 at 228, it determines whether a conflict exists between the reserve request and other reserve requests that have previously been received at 230. In other words, the port checks the reserve information it has stored for other reservations performed by other ports. iPort2 may then send a reserve response to the host at 232. This reserve response may indicate whether a conflict exists. In this example, iPort2 determines that a conflict exists and notifies the host of the conflict. As a result, iPort2 does not send reserve intention notifications to the other ports exporting the volume.

In accordance with one embodiment, the reservation information for a set of ports that exports a volume is stored at a single location or network device that is external to each of the set of ports. This location or network device may be referred to as a “shared disk” on which each port (e.g. iPort) has a segment for each region of the volume. Each segment may be used to store reservation status information for the corresponding region of the volume. The reservation information may be organized according to volume region and/or port.

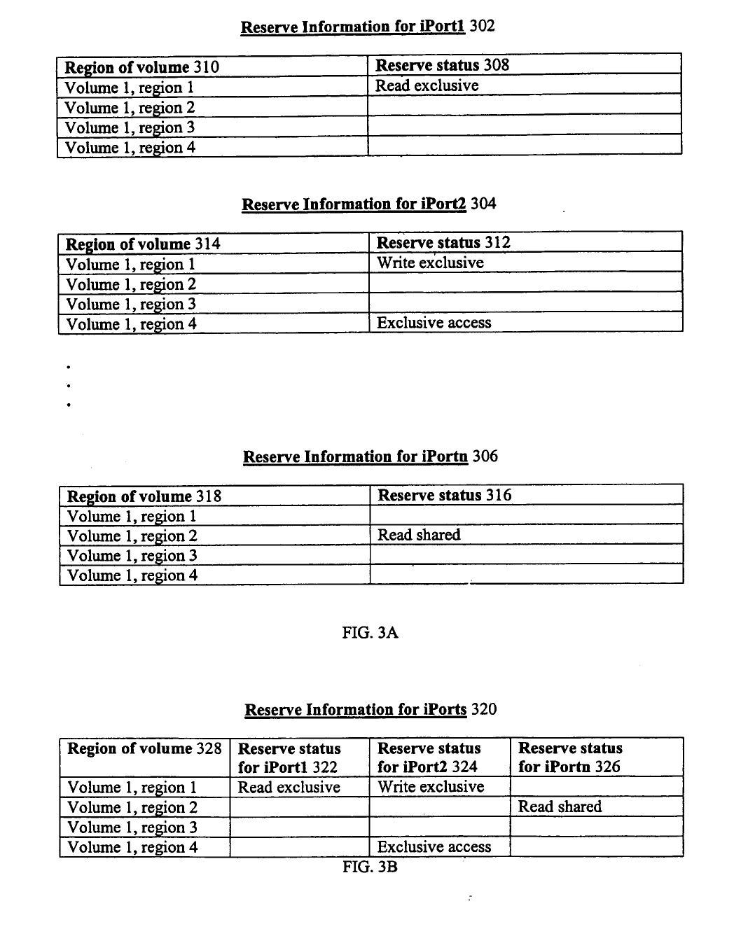

FIGS. 3A-3B are exemplary data structures that may be used for storing reserve information for a plurality of ports in accordance with a second embodiment of the invention. As shown in FIG. 3A, the reserve information includes reserve information for each of the ports exporting Volume 1 as shown at 302, 304, and 306. For instance, the reserve information 302 for iPort 1 includes a reserve status 308 for each region of the volume as shown at 310. In this example, iPort1 has reserved region 1 of the volume with a read exclusive reservation. Similarly, the reserve information 304 for iPort 2 includes a reserve status 312 for each region of the volume as shown at 314. In this example, iPort2 has reserved region 1 of the volume with a write exclusive reservation and region 4 of the volume with an exclusive access reservation. The reserve information 306 for iPortn includes a reserve status 316 for each region of the volume as shown at 318. In this example, iPortn has reserved region 2 of the volume with a read shared reservation.

FIG. 3B illustrates an alternate data structure for storing the reserve status for each region of the volume for each of the ports exporting the volume. In this example, the reserve information is organized according to region. More particularly, the reserve information 320 for the set of ports includes a reserve status for each of the iPorts as shown at 322, 324, and 326 corresponding to the region of the volume that is reserved as shown at 328. In accordance with one embodiment, a reserve status of 1 indicates that the iPort has reserved the corresponding region of the volume, while a reserve status of 0 indicates that the iPort has not reserved the corresponding region of the volume. Thus, a different reserve status column may be provided for each reservation type.

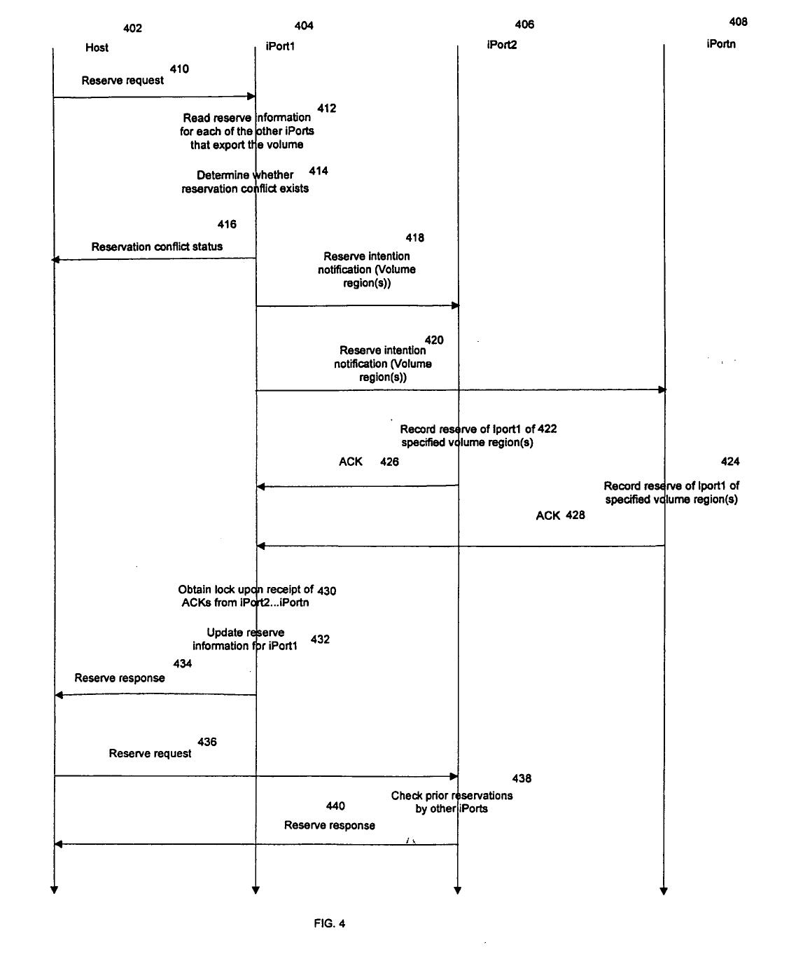

If the reserve information is stored at a central location such as a shared disk, the storing and accessing of the reserve information need not be performed locally. FIG. 4 is a process flow diagram illustrating a method of processing a reserve request using message passing between ports and reserve information that is stored for the ports in a manner such as that illustrated in FIG. 3A or FIG. 3B. Steps performed by a host and ports iPort1, iPort2 . . . iPortn are described with reference to vertical lines 402, 404, 406, and 408, respectively. When one of the ports that exports the volume, iPort1, receives a reserve request from the host at 410, it accesses reserve information for a set of ports exporting the volume at 412. As set forth above, in accordance with one embodiment, the reserve information for the ports that export the volume is maintained in a central location (e.g., shared disk) that is accessible by each of the ports. Therefore, in this example, the port, iPort1, reads the reserve information from the shared disk. The reserve information that is accessed from the shared disk may include the reserve information for other iPorts that export the volume. From this information, iPort1 determines at 414 whether a reservation conflict exists between the portion of the volume identified in the reserve request and the reserve information that has been accessed. The port, iPort1, may then send a reserve conflict status to the host at 416 indicating whether a reservation conflict exists.

When a reservation conflict does not exist, the port that has received the reserve request sends a reserve intention notification to each of the other ports that exports the volume at 418 and 420. Each of the ports receiving the reserve intention notification may update its own local reserve information at 422 and 424, respectively, to indicate that iPort1 has reserved the requested region(s) of the volume as identified in the reserve notification. The ports may also acknowledge the receipt of the notification message by sending an acknowledgement at 426 and 428, respectively. The port, iPort1, may then obtain a lock of the reserved region(s) at 430. For instance, the port may obtain a lock after an acknowledgement is received from each of the set of ports to which a reserve notification was sent. The port, iPort1, may then update the centrally located reserve information at 432 indicating that it has reserved the portion of the volume. The port may also update locally maintained reserve information, as well. In addition, iPort1 may send a reserve response to the host at 434 indicating whether the reservation was successful. In this manner, iPort1 may update the reserve information, whether the reserve information is stored locally and/or at a shared disk.

When other ports that export the volume send a reserve request as shown at 436, they perform a similar process to check whether reservations by other iPorts present a reservation conflict at 438. More particularly, this reserve information may be obtained from the shared disk. In this example, upon determining whether a reservation conflict exists, iPort2 sends a reserve response to the host at 440.

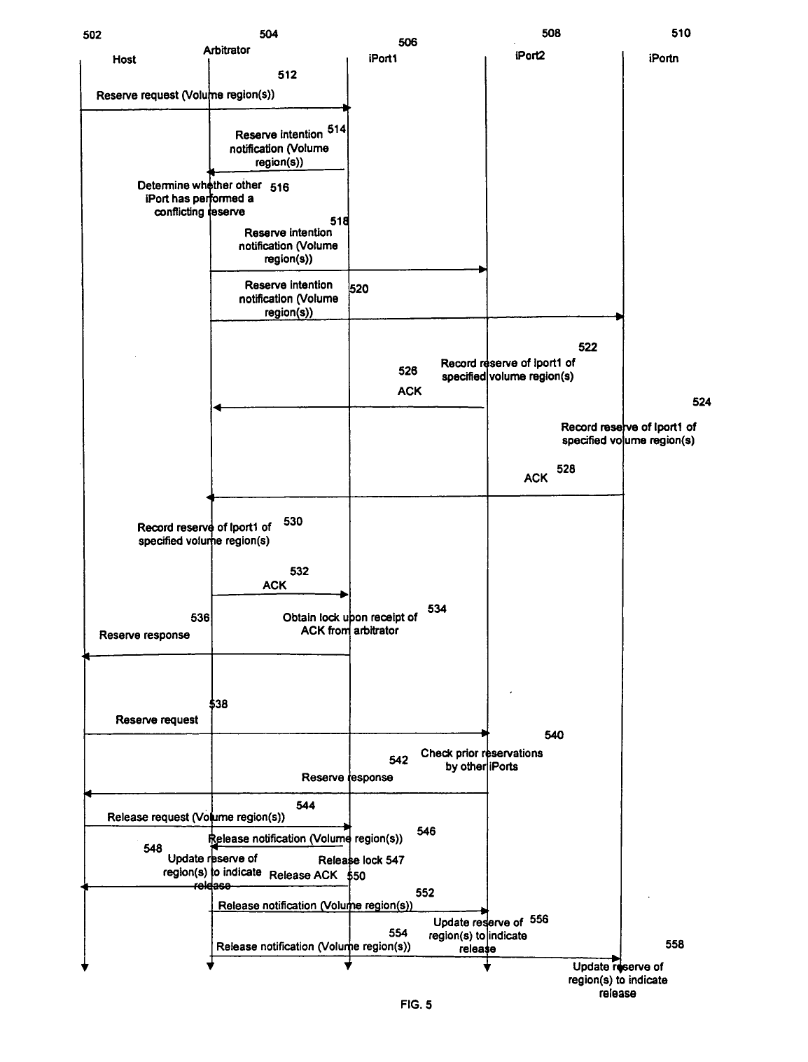

While it is possible to send messages such as notifications directly to other ports, it may be desirable to send messages via an arbitrator. The arbitrator may be implemented, for example, on a separate network device. FIG. 5 is a process flow diagram illustrating a method of processing reserve requests via an arbitrator in accordance with a third embodiment of the invention. Steps performed by a host, arbitrator, and ports iPort1, iPort2 . . . iPortn are represented by vertical lines 502, 504, and 506-510, respectively. When a reserve request identifying at least a portion of a volume is received from a host at 512, the port receiving the reserve request sends a reserve intention notification to an arbitrator at 514. The reserve intention notification may indicate the portion(s) of the volume being reserved, as well as the port sending the reserve intention notification (i.e., the port that has received the reserve request).

The arbitrator is adapted for “managing” reserve requests received by a plurality of ports. More particularly, upon receiving the reserve intention request from iPort1, the arbitrator may determine whether a reservation conflict exists at 516. In other words, the arbitrator determines whether another iPort has performed a conflicting reservation. The reserve information may be stored locally by the arbitrator and/or on a separate network device. Assuming that no conflict exists, the arbitrator transmits a reserve intention notification to a set of one or more ports exporting the volume as shown at 518 and 520. Upon receiving the reserve intention notification, each port may update local reserve information as shown at 522 and 524 to indicate that a particular region or regions of a volume have been reserved. This local information may also indicate the port that has reserved these region(s). Each of these ports may also send an acknowledgement, as shown at 526 and 528, respectively.

The arbitrator records the reservation of the port, Iport1, of the specified region(s) at 530. The reserve information may identify the port that has reserved the specified region(s). In this example, the arbitrator waits to update the reserve information until it receives the acknowledgements from each of the ports to which it has sent a reserve intention notification. In addition, after it has received the acknowledgements, it sends an acknowledgement to the port that has received the reserve request at 532, Iport1.

Upon receipt of the acknowledgement from the arbitrator, the port, Iport1, obtains a lock of the requested portion(s) of the volume at 534 and may update its local reserve information. The port may then send a reserve response at 536 indicating whether the reservation was successful at 536

When another port that exports the volume such as Iport2 receives a reserve request at 538, it checks the reserve information to determine whether a reservation conflict exists at 540. In this example, it ascertains whether the reservation by Iport1 conflicts whether the currently requested reservation. The port, Iport2, may then send a reserve response at 542 indicating whether the reservation was successful. In this example, the port, Iport2, notifies the host that a conflict exists and the port does not continue to notify the arbitrator of the requested reservation.

When the host sends a release request to Iport1 at 544 indicating that it intends to release the lock it previously obtained of the portion(s) of the volume, Iport1 sends a release notification to the arbitrator at 546 indicating a release of the lock of the portion(s) of the volume. In addition, the port, Iport1, releases the lock at 547 and may update its local reserve information. The arbitrator also updates the reserve information to indicate that the lock has been released at 548. The port, Iport1, may also send an acknowledgement of the release of the lock to the host at 550.

Upon receiving the release notification, the arbitrator sends a release notification to a set of one or more ports exporting the volume as shown at 552 and 554. Each of these ports may each update their locally maintained reserve information at 556 and 558, respectively. In this manner, each of the ports may have access to reserve information enabling them to handle subsequent reserve requests appropriately.

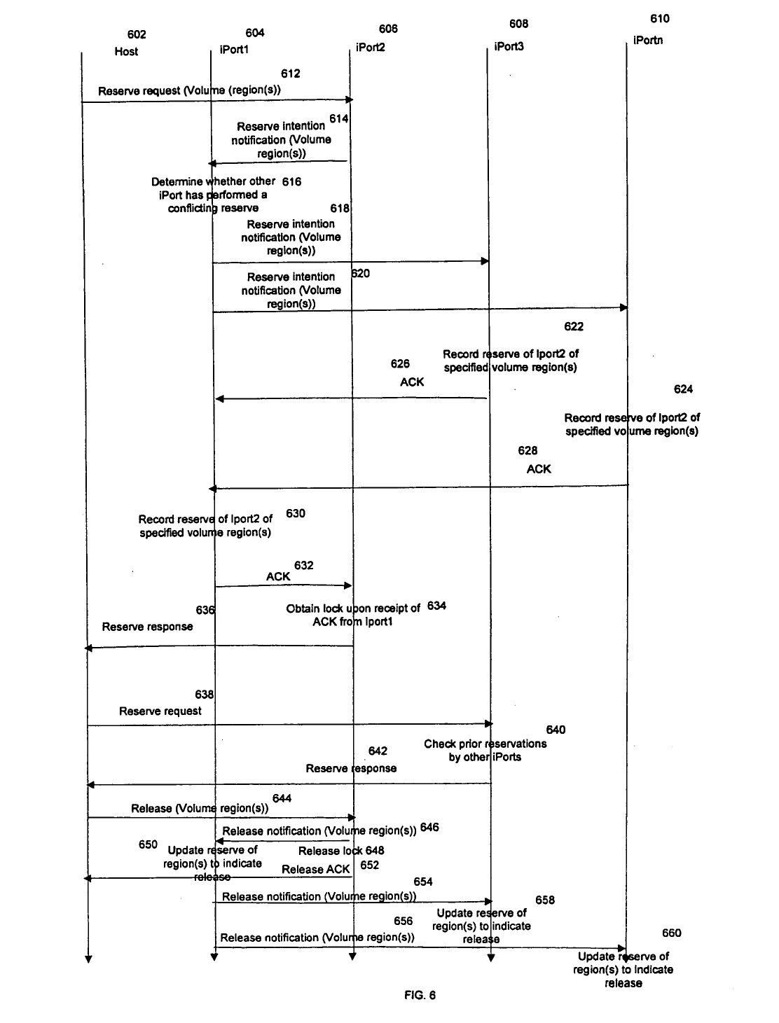

An arbitrator may be implemented in a variety of manners. For instance, an arbitrator may be associated with a volume or set of volumes, and therefore support those ports that export the corresponding volume(s). Moreover, an arbitrator may be implemented via a network device or port of a network device. FIG. 6 is a process flow diagram illustrating a method of processing reserve requests via an arbitrator implemented at a single port in accordance with a fourth embodiment of the invention. Steps performed by a host and ports exporting a volume, iPort1, iPort2, iPort3 . . . iPortn are represented by vertical lines 602, 604, 606, 608, and 610, respectively. In this example, iPort1 functions as an arbitrator for the volume (or set of volumes) exported by the ports iPort1, iPort2, iPort3 . . . iPortn. Thus, when a reserve request is received by iPort2 at 612, iPort2 sends a reserve intention notification to the arbitrator, iPort1, at 614. The arbitrator then determines whether a reservation conflict exists for the requested portion(s) of the volume at 616. In other words, iPort1 determines whether another port has performed a conflicting reserve.

Assuming that the arbitrator has not identified a reservation conflict, the arbitrator sends a reserve intention notification to a set of ports exporting the volume at 618 and 620. In this example, the arbitrator sends a reserve intention notification identifying the reserved portion(s) of the volume to iPort3 and iPortn. The arbitrator need not notify the requesting port, iPort2. The ports receiving the reserve intention notifications may record the reservation of the portion(s) of the volume in their reserve information at 622 and 624, and may also send an acknowledgement at 626 and 628, respectively. Thereafter, the ports, iPort3 and iPortn may process reserve requests appropriately by accessing the reserve information that has been recorded.

If acknowledgements are transmitted, the arbitrator waits for acknowledgements from the ports to which reserve intention notifications have been sent before recording the reservation of the portion(s) of the volume at 630 and sending an acknowledgement to the requesting port, iPort2, at 632. Of course, where acknowledgements are not supported, the arbitrator may assume that the ports have received and processed the notifications.

Upon receiving the acknowledgement from the arbitrator, iPort2 obtains a lock of the requested portion(s) of the volume at 634. The port, iPort2, may also send a reserve response at 636 to the host indicating whether the reservation was successful.

When another port that exports the volume, iPort3, receives a reserve request at 638, it may check its reserve information to determine whether a reservation conflict exists at 640. The port receiving the second reserve request, iPort3, may then send a reserve response indicating whether the reservation was successful to the host at 642. In this example, since a conflict exists, iPort3 does not continue to send a reserve intention notification to the arbitrator, iPort1.

When the host sends a release request to iPort2 at 644, iPort2 sends a release notification indicating that a lock of the previously requested portion(s) of the volume is being released to the arbitrator, iPort1, at 646. The port, iPort2, releases the lock at 648 and may also update its reserve information (e.g., local reserve information) accordingly. In addition, the arbitrator may also update its local reserve information at 650. Upon release of the lock, iPort2 may send a release acknowledgement to the host at 652 indicating whether the release of the lock has been performed.

Once the release notification has been received by the arbitrator, iPort1, the arbitrator sends a release notification to the ports to which it previously sent reserve intention notifications. More particularly, these ports may include the ports that export the volume, but need not include the port that initiated the reserve request, iPort2. Thus, the arbitrator sends a release notification to ports iPort3 and iPortn at 654 and 656, respectively. The ports, iPort3 and iPortn, may also update their local reserve information accordingly at 658 and 660, respectively.

In accordance with one embodiment, an arbitrator is associated with a volume or set of volumes. In this manner, a different arbitrator may be associated with a different volume or set of volumes. Moreover, each arbitrator may be implemented at a different port. For instance, each arbitrator port may be implemented by a master port as set forth in patent application Ser. No. 10/056,238, Attorney Docket No. ANDIP003, entitled “Methods and Apparatus for Implementing Virtualization of Storage in a Storage Area Network,” by Edsall et al, filed on Jan. 23, 2002, which is incorporated herein by reference for all purposes. In other words, a master port may be associated with a volume or set of volumes.

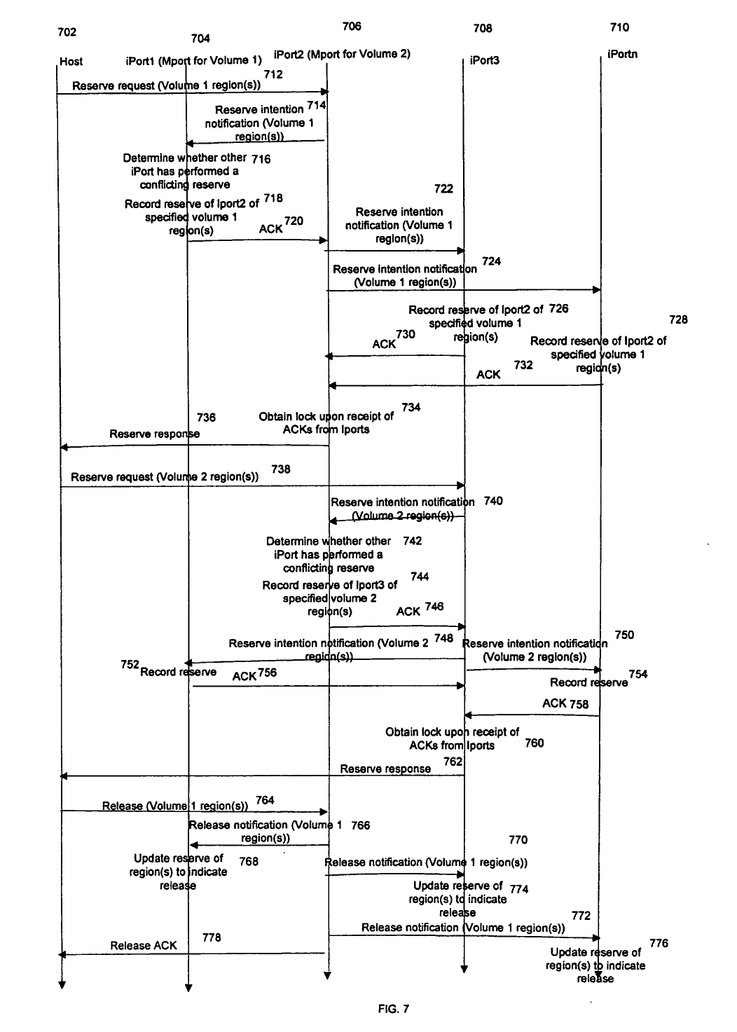

FIG. 7 is a process flow diagram illustrating a method of processing reserve requests via an arbitrator implemented at a master port for the volume in accordance with a fifth embodiment of the invention. Steps performed by a host, iPort1, iPort2, iPort3, and iPortn are represented by vertical lines 702, 704, 706, 708, and 710, respectively. In this example, iPort1 serves as the arbitrator for Volume 1 and iPort2 serves as the arbitrator for Volume 2. More particularly, iPort1 is a master port for Volume 1 and iPort2 is a master port for Volume 2.

In this example, the host sends a reserve request identifying one or more portion(s) of Volume 1 to iPort2 at 712. Although iPort2 is an arbitrator for Volume 2, it is not an arbitrator for Volume 1. As a result, iPort2 sends a reserve intention notification identifying the portion(s) of Volume 1 to the arbitrator for Volume 1, iPort1, as shown at 714. The arbitrator for Volume 1, iPort1, determines whether a reservation conflict exists at 716 by determining whether another port has performed a conflicting reserve. Assuming that no conflict exists, iPort1 may record the reservation of the portion(s) of Volume 1 at 718. In addition, the arbitrator for Volume 1, iPort1, may send an acknowledgement to iPort2 indicating that no reservation conflict exists as shown at 720.

Upon receipt of the acknowledgement from the arbitrator, the port responsible for reserving the requested portion(s) of Volume 1, iPort2, sends a reserve intention notification to a set of ports that export the volume, Volume 1. As shown, a reserve intention notification is sent to the remaining ports, iPort3 and iPortn, that export Volume 1 and are not yet aware of the reservation as shown at 722 and 724, respectively. The ports iPort3 and iPortn may then record the reservation of the portion(s) of Volume 1 as shown at 726 and 728, respectively. For instance, local reserve information may identify the portion(s) of Volume 1 and/or the port requesting the reservation, iPort2. Upon receiving the reserve intention notification and/or recording the reservation, the ports, iPort3 and iPortn, may send an acknowledgement to iPort 2, as shown at 730 and 732, respectively. The requesting port, iPort2, obtains a lock of the requested portion(s) of Volume 1 at 734 and may also record the reservation in its local reserve information. In accordance with one embodiment, the requesting port waits until it has received acknowledgements from each of the ports that have received reserve intention notifications to obtain the lock. The requesting port, iPort2, may also send a reserve response to the host at 736 indicating whether the reservation was successful.

The host may also wish to reserve portion(s) of Volume 2. In this example, the host sends a reserve request at 738 identifying portion(s) of Volume 2 to iPort3. Although iPort3 exports Volume 2, it is not the arbitrator for Volume 2. As a result, iPort 3 sends a reserve intention notification identifying the requested portion(s) of Volume 2 to the arbitrator for Volume 2, iPort2, as shown at 740. The arbitrator for Volume 2, iPort2, determines whether a reservation conflict exists at 742 by determining whether another port has performed a conflicting reserve. Assuming that no conflict exists, iPort2 may record the reservation of the portion(s) of Volume 2 at 744. In addition, the arbitrator for Volume 2, iPort2, may send an acknowledgement to iPort3 indicating that no reservation conflict exists as shown at 746.

Upon receipt of the acknowledgement from the arbitrator for Volume 2, the port responsible for reserving the requested portion(s) of Volume 2, iPort3, sends a reserve intention notification to a set of ports that export the volume, Volume 2. As shown, a reserve intention notification is sent to the remaining ports, iPort1 and iPortn, that export Volume 2 and are not yet aware of the reservation as shown at 748 and 750, respectively. The ports iPort1 and iPortn may then record the reservation of the portion(s) of Volume 2 as shown at 752 and 754, respectively. For instance, local reserve information may identify the portion(s) of Volume 2, as well as the port requesting the reservation, iPort3. Upon receiving the reserve intention notification and/or recording the reservation, the ports, iPort1 and iPortn, may send an acknowledgement to iPort 3, as shown at 756 and 758, respectively. The requesting port, iPort3, obtains a lock of the requested portion(s) of Volume 2 at 760 and may also record the reservation in its local reserve information. In accordance with one embodiment, the requesting port waits until it has received acknowledgements from each of the ports that have received reserve intention notifications to obtain the lock. The requesting port, iPort3, may also send a reserve response to the host at 762 indicating whether the reservation was successful.

When the host wishes to release the lock of the portion(s) of Volume 1, it sends a release request. In this example, the release request is sent to iPort2 at 764. Even though iPort2 exports Volume 1, it is not the arbitrator for Volume 1. As a result, iPort2 sends a release notification to the arbitrator for Volume 1, iPort1, as shown at 766. The arbitrator for Volume 1, iPort1, updates its reserve information (e.g., maintained locally and/or at a separate location) to indicate that the lock has been released at 768. In addition, the remaining ports, iPort3 and iPortn, are sent a release notification at 770 and 772, respectively. The release notifications may be sent by the arbitrator or by iPort2 (as shown in this example). The ports iPort3 and iPortn may update their reserve information accordingly at 774 and 776, respectively. The port that received the release request, iPort2, may send a release acknowledgement to the host at 778 confirming that the lock has been released.

In the above-described embodiments, various operations relating to acquiring and releasing locks are described. In addition, operations relating to accessing and modifying reserve information, as well as sending and receiving corresponding reserve and release notification messages are set forth. However, it is important to note that these examples are merely illustrative, and therefore other operations and corresponding notifications are contemplated. Moreover, the disclosed embodiments may be implemented using a variety of message types.

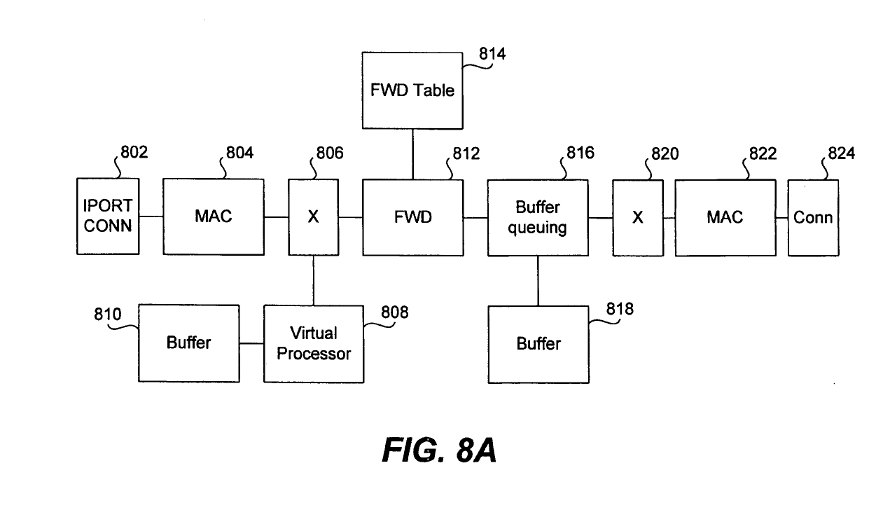

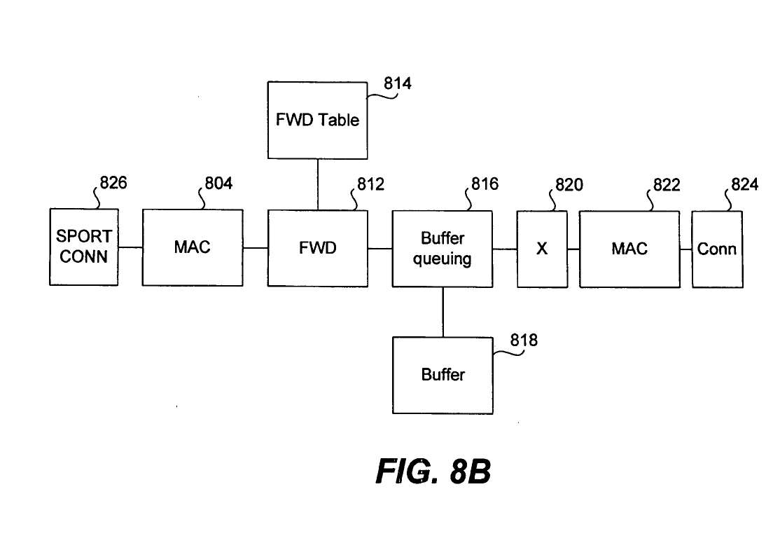

Various switches within a storage area network may be virtualization switches supporting virtualization functionality. FIG. 8A is a block diagram illustrating an exemplary virtualization switch in which various embodiments of the present invention may be implemented. As shown, data is received by an intelligent, virtualization port via a bidirectional connector 802. In association with the incoming port, Media Access Control (MAC) block 804 is provided, which enables frames of various protocols such as Ethernet or fibre channel to be received. In addition, a virtualization intercept switch 806 determines whether an address specified in an incoming frame pertains to access of a virtual storage location of a virtual storage unit representing one or more physical storage locations on one or more physical storage units of the storage area network. In this example, the frame is received via a bi-directional connector 802 and the new or modified frame exits from the switch fabric 820. However, it is important to note that a virtualization switch may be implemented in an alternate manner. For instance, the frame may be received from the fabric 820, redirected by 806 to 808, virtualized and sent back to the switch fabric 820. This is important when a host and disk are connected to a standard line card such as that illustrated in FIG. 8B, and the host and disk share several virtualization cards such as that illustrated in FIG. 8A.

When the virtualization intercept switch 806 determines that the address specified in an incoming frame pertains to access of a virtual storage location rather than a physical storage location, the frame is processed by a virtualization processor 808 capable of performing a mapping function such as that described above. More particularly, the virtualization processor 808 obtains a virtual-physical mapping between the one or more physical storage locations and the virtual storage location. In this manner, the virtualization processor 808 may look up either a physical or virtual address, as appropriate. For instance, it may be necessary to perform a mapping from a physical address to a virtual address or, alternatively, from a virtual address to one or more physical addresses.

Once the virtual-physical mapping is obtained, the virtualization processor 808 may then employ the obtained mapping to either generate a new frame or modify the existing frame, thereby enabling the frame to be sent to an initiator or a target specified by the virtual-physical mapping. For instance, a frame may be replicated multiple times in the case of a mirrored write. This replication requirement may be specified by a virtual-physical mapping function. In addition, the source address and/or destination addresses are modified as appropriate. For instance, for data from the target, the virtualization processor replaces the source address, which was originally the physical LUN address with the corresponding virtual LUN and virtual address.

In the destination address, the port replaces its own address with that of the initiator. For data from the initiator, the port changes the source address from the initiator's address to the port's own address. It also changes the destination address from the virtual LUN/address to the corresponding physical LUN/address. The new or modified frame may then be provided to the virtualization intercept switch 306 to enable the frame to be sent to its intended destination.

While the virtualization processor 808 obtains and applies the virtual-physical mapping, the frame or associated data may be stored in a temporary memory location (e.g., buffer) 810. In addition, it may be necessary or desirable to store data that is being transmitted or received until it has been confirmed that the desired read or write operation has been successfully completed. As one example, it may be desirable to write a large amount of data to a virtual LUN, which must be transmitted separately in multiple frames. It may therefore be desirable to temporarily buffer the data until confirmation of receipt of the data is received. As another example, it may be desirable to read a large amount of data from a virtual LUN, which may be received separately in multiple frames. Furthermore, this data may be received in an order that is inconsistent with the order in which the data should be transmitted to the initiator of the read command. In this instance, it may be beneficial to buffer the data prior to transmitting the data to the initiator to enable the data to be re-ordered prior to transmission. Similarly, it may be desirable to buffer the data in the event that it is becomes necessary to verify the integrity of the data that has been sent to an initiator (or target).

The new or modified frame is then received by a forwarding engine 812, which obtains information from various fields of the frame, such as source address and destination address. The forwarding engine 812 then accesses a forwarding table 814 to determine whether the source address has access to the specified destination address. More specifically, the forwarding table 814 may include physical LUN addresses as well as virtual LUN addresses. The forwarding engine 812 also determines the appropriate port of the switch via which to send the frame, and generates an appropriate routing tag for the frame.

Once the frame is appropriately formatted for transmission, the frame will be received by a buffer queuing block 816 prior to transmission. Rather than transmitting frames as they are received, it may be desirable to temporarily store the frame in a buffer or queue 818. For instance, it may be desirable to temporarily store a packet based upon Quality of Service in one of a set of queues that each correspond to different priority levels. The frame is then transmitted via switch fabric 820 to the appropriate port. As shown, the outgoing port has its own MAC block 822 and bi-directional connector 824 via which the frame may be transmitted.

One or more ports of the virtualization switch (e.g., those ports that are intelligent virtualization ports) may implement the disclosed SCSI reserve functionality. For instance, the virtualization processor 808 of a port that implements virtualization functionality may also perform SCSI reserve functionality such as that disclosed herein. Of course, this example is merely illustrative. Therefore, it is important to note that a port or network device that implements SCSI reserve functionality may be separate from a port or network device that implements virtualization functionality.

As described above, all switches in a storage area network need not be virtualization switches. In other words, a switch may be a standard switch in which none of the ports implement “intelligent,” virtualization functionality. FIG. 8B is a block diagram illustrating an exemplary standard switch in which various embodiments of the present invention may be implemented. As shown, a standard port 826 has a MAC block 804. However, a virtualization intercept switch and virtualization processor such as those illustrated in FIG. 8A are not implemented. A frame that is received at the incoming port is merely processed by the forwarding engine 812 and its associated forwarding table 814. Prior to transmission, a frame may be queued 816 in a buffer or queue 818. Frames are then forwarded via switch fabric 820 to an outgoing port. As shown, the outgoing port also has an associated MAC block 822 and bi-directional connector 824.

As described above, the present invention may be implemented, at least in part, by a virtualization switch. Virtualization is preferably performed on a per-port basis rather than per switch. Thus, each virtualization switch may have one or more virtualization ports that are capable of performing virtualization functions, as well as ports that are not capable of such virtualization functions. In one embodiment, the switch is a hybrid, with a combination of line cards as described above with reference to FIG. 8A and FIG. 8B.

Although the network devices described above with reference to FIG. 8A and 8B are described as switches, these network devices are merely illustrative. Thus, other network devices such as routers may be implemented to perform functionality such as that described above. Moreover, the above-described network devices are merely illustrative, and therefore other types of network devices may be implemented to perform the disclosed SCSI reserve functionality. In addition, other message types or system configurations are also contemplated.

Although illustrative embodiments and applications of this invention are shown and described herein, many variations and modifications are possible which remain within the concept, scope, and spirit of the invention, and these variations would become clear to those of ordinary skill in the art after perusal of this application. Moreover, the present invention would apply regardless of the context and system in which it is implemented. Thus, broadly speaking, the present invention need not be performed using the operations or data structures described above.

In addition, although an exemplary switch is described, the above-described embodiments may be implemented in a variety of network devices (e.g., servers) as well as in a variety of mediums. For instance, instructions and data for implementing the above-described invention may be stored on a disk drive, a hard drive, a floppy disk, a server computer, or a remotely networked computer. Accordingly, the present embodiments are to be considered as illustrative and not restrictive, and the invention is not to be limited to the details given herein, but may be modified within the scope and equivalents of the appended claims.

What is claimed is:

1. A network device adapted for processing a reserve request, the reserve request requesting a reservation of at least a portion of a volume in a system implementing network-based virtualization of storage, comprising:
a processor; and
a memory, at least one of the processor and the memory being adapted for:
receiving the reserve request from a host;
sending a reserve intention notification, the reserve intention notification indicating the at least a portion of the volume being reserved; and
obtaining a lock corresponding to reserve request, the lock acquiring a lock of the at least a portion of the volume.

2. The network device as recited in claim 1, wherein the reserve request is one of a read exclusive request, write exclusive request, exclusive access request, and read shared request.

3. The network device as recited in claim 1, wherein the network device includes a port including the processor and the memory.

4. The network device as recited in claim 1, wherein sending a reserve intention notification comprises:
sending a reserve intention notification to an arbitrator.

5. The network device as recited in claim 4, at least one of the processor and the memory being further adapted for:
receiving a release request from the host, the release request requesting a release of at least a portion of the volume; and
sending a release notification to the arbitrator, the release notification indicating that the at least a portion of the volume is no longer reserved.

6. The network device as recited in claim 4, at least one of the processor and the memory being further adapted for:
receiving an acknowledgement from the arbitrator;wherein obtaining a lock is performed when an acknowledgement is received from the arbitrator.

7. The network device as recited in claim 5, wherein sending a reserve intention notification further comprises:
sending a reserve intention notification to a set of one or more ports exporting the volume.

8. The network device as recited in claim 7, at least one of the processor and the memory being further adapted for:
receiving an acknowledgement from the arbitrator;
wherein sending a reserve intention notification to a set of one or more ports exporting the volume is performed when the acknowledgement is received from the arbitrator.

9. The network device as recited in claim 4, wherein the arbitrator is a port.

10. The network device as recited in claim 3, wherein sending a reserve intention notification comprises:
sending a reserve intention notification to a set of one or more ports exporting the volume.

11. The network device as recited in claim 10, at least one of the processor and the memory being further adapted for:
receiving an acknowledgement from each of the set of ports to which a reserve intention notification was sent;
wherein obtaining a lock is performed when an acknowledgement is received from each of the ports to which a reserve intention notification was sent.

12. The network device as recited in claim 1, at least one of the processor and the memory being further adapted for:
accessing reserve information for a set of ports exporting the volume; and
determining whether a conflict exists between the at least a portion of the volume identified in the reserve request and the reserve information;
wherein sending a reserve intention notification and obtaining a lock are performed when a conflict does not exist.

13. The network device as recited in claim 12, at least one of the processor and the memory being further adapted for:
sending a reserve conflict status to the host.

14. The network device as recited in claim 1, at least one of the processor and the memory being further adapted for:
updating reserve information indicating that the at least a portion of the volume has been reserved.

15. The network device as recited in claim 14, wherein the network device includes a port including the processor and the memory, and wherein the reserve information that is updated is associated with the port.

16. The network device as recited in claim 12, wherein the reserve information for the set of ports exporting the volume and the port of the network device is stored at a second network device.

17. A network device adapted for processing a reserve request, the reserve request requesting a reservation of at least a portion of a volume in a system implementing network-based virtualization of storage, comprising:
a processor; and
a memory, at least one of the processor and the memory being adapted for:
receiving a reserve intention notification transmitted in response to the reserve request, the reserve intention notification indicating the at least a portion of the volume being reserved; and
storing information indicating that a lock acquiring a lock of the at least a portion of the volume has been obtained.

18. The network device as recited in claim 17, wherein the reserve request is one of a read exclusive request, write exclusive request, exclusive access request, and read shared request.

19. The network device as recited in claim 17, at least one of the processor and the memory being further adapted for:
determining whether a conflict exists between the reserve request and other reserve requests that have been received; and
sending a response to a host from which the reserve request was received, the response indicating whether a conflict exists.

20. The network device as recited in claim 17, wherein the network device includes a port including the processor and the memory.

21. The network device as recited in claim 17, wherein the network device includes an arbitrator adapted for managing reserve requests received by a plurality of ports.

22. The network device as recited in claim 17, at least one of the processor and the memory being further adapted for:
transmitting a reserve intention notification to a set of one or more ports exporting the volume, the reserve intention notification indicating the at least a portion of the volume being reserved.

23. The network device as recited in claim 22, at least one of the processor and the memory being further adapted for:
sending an acknowledgement to the port that has received the reserve request after an acknowledgement is received from each of the set of one or more ports exporting the volume.

24. The network device as recited in claim 22, at least one of the processor and the memory being further adapted for:
receiving a release notification from the port; and
sending a release notification to each of the set of one or more ports exporting the volume.

25. The network device as recited in claim 21, wherein the arbitrator is a port of the network device.

26. The network device as recited in claim 25, wherein the port is a master port for the volume, wherein each volume has an associated master port.

27. The network device as recited in claim 21, wherein the arbitrator is associated with the volume.

28. A method of processing a reserve request, the reserve request requesting a reservation of at least a portion of a volume in a system implementing network-based virtualization of storage, comprising:
receiving the reserve request from a host;
sending a reserve intention notification, the reserve intention notification indicating the at least a portion of the volume being reserved; and
obtaining a lock corresponding to reserve request, the lock acquiring a lock of the at least a portion of the volume.

29. The method as recited in claim 28, wherein the reserve request is one of a read exclusive request, write exclusive request, exclusive access request, and read shared request.

30. A method of processing a reserve request, the reserve request requesting a reservation of at least a portion of a volume in a system implementing network-based virtualization of storage, comprising:
receiving a reserve intention notification transmitted in response to the reserve request, the reserve intention notification indicating the at least a portion of the volume being reserved; and
storing information indicating that a lock acquiring a lock of the at least a portion of the volume has been obtained.

31. The method as recited in claim 30, wherein the reserve request is one of a read exclusive request, write exclusive request, exclusive access request, and read shared request.

32. A network device adapted for processing a reserve request, the reserve request requesting a reservation of at least a portion of a volume in a system implementing network-based virtualization of storage, comprising:
means for receiving the reserve request from a host;
means for sending a reserve intention notification, the reserve intention notification indicating the at least a portion of the volume being reserved; and
means for obtaining a lock corresponding to reserve request, the lock acquiring a lock of the at least a portion of the volume.
